(19) United States
(12) Patent Application Publication
(10) Pub. No.: US 2023/0042969 A1
(43) Pub. Date: Feb. 9, 2023

(54) ITEM CLASSIFICATION ASSISTANCE SYSTEM, METHOD, AND PROGRAM

(71) Applicant: NEC Corporation, Minato-ku, Tokyo (JP)

(72) Inventor: Masafumi OYAMADA, Tokyo (JP)

(73) Assignee: NEC Corporation, Minato-ku, Tokyo (JP)

(21) Appl. No.: 17/797,357

(22) PCT Filed: Feb. 25, 2020
(86) PCT No.: PCT/JP2020/007494

§ 371 Date: Aug. 3, 2022

(51) Int. Cl. G06K 9/00; G06F 3/0482

(52) U.S. Cl. CPC G06K 9/00496; G06F 3/0482

(57) ABSTRACT

The group determination means 13 determines a group of item names from a set of item names of unclassified items. The display control means 14 displays individual item names belonging to the group, and displays a plurality of candidates of a classification name for each item represented by each item name belonging to the group in a user-specifiable manner. When one of the plurality of candidates of the classification name is specified by a user, the classification determination means 16 determines that each item represented by each item name belonging to the group is classified by the classification name specified by the user.

### TECHNICAL FIELD

This invention relates to an item classification assistance system, an item classification assistance method, and an item classification assistance program that assist item classification.

### BACKGROUND ART

In some cases, data may be created that associates a commodity with a classification name for that commodity. FIG. 12 is a schematic diagram showing an example of data that associates a commodity with a classification name. A commodity is represented by a commodity name. In the example shown in FIG. 12, for example, a commodity with a commodity name “Great Detective C 1/10” is classified as a “figure” and a commodity with a commodity name “Mysterious Thief X poster” is classified as a “poster”.

The data that associates commodities with classification names is used, for example, as teacher data in machine learning to forecast the demand for commodities.

The process of defining a classification name for a commodity is generally done manually for each commodity.

Patent literature 1 describes a technique for classifying commodities or services into appropriate categories.

### CITATION LIST

### Patent Literature

PTL1: Japanese Patent Application Laid-Open No. 2019-164402

### SUMMARY OF INVENTION

### Technical Problem

Patent literature 1 does not disclose defining a classification name for classification of commodities.

As mentioned above, the process of defining a classification name for a commodity is generally done manually for each commodity. Therefore, the process is very time-consuming.

In addition, it is desirable to be able to easily define a classification name of an item, not only for commodities, but also for items other than commodities.

Therefore, the purpose of the present invention is to provide an item classification assistance system, an item classification assistance method, and an item classification assistance program that can assist users to easily define a classification name of items to be classified.

### Solution to Problem

An item classification assistance system according to the present invention includes group determination means for determining a group of item names from a set of item names of unclassified items; display control means for displaying individual item names belonging to the group, and displaying a plurality of candidates of a classification name for each item represented by each item name belonging to the group in a user-specifiable manner; and classification determination means for, when one of the plurality of candidates of the classification name is specified by a user, determining that each item represented by each item name belonging to the group is classified by the classification name specified by the user.

In an item classification assistance method according to the present invention, one or more computers determine a group of item names from a set of item names of unclassified items; display individual item names belonging to the group, and display a plurality of candidates of a classification name for each item represented by each item name belonging to the group in a user-specifiable manner; and when one of the plurality of candidates of the classification name is specified by a user, determine that each item represented by each item name belonging to the group is classified by the classification name specified by the user.

An item classification assistance program according to the present invention causes a computer to execute: a group determination process of determining a group of item names from a set of item names of unclassified items; a display control process of displaying individual item names belonging to the group, and displaying a plurality of candidates of a classification name for each item represented by each item name belonging to the group in a user-specifiable manner; and a classification determination process of, when one of the plurality of candidates of the classification name is specified by a user, determining that each item represented by each item name belonging to the group is classified by the classification name specified by the user. The present invention may also be a computer-readable recording medium in which the above item classification assistance program is recorded.

### Advantageous Effects of Invention

According to the present invention, it is possible to assist users to easily define a classification name of items to be classified.

### BRIEF DESCRIPTION OF DRAWINGS

FIG. 1 It depicts a block diagram showing a configuration example of an item classification assistance system of the example embodiment of the present invention.

FIG. 2 It depicts an explanatory diagram showing an example of a screen displayed on the display device 5 by the display control unit 4.

FIG. 3 It depicts an explanatory diagram showing an example of a state in which a check is removed from check box 51.

FIG. 4 It depicts an explanatory diagram showing an example of the display after button 52 is operated.

FIG. 5 It depict a flowchart showing an example of the processing flow of the example embodiment of the present invention.

FIG. 6 It depicts an explanatory diagram showing an example of relationship between a predetermined digit of an employee number, an affiliation department and candidates for a predetermined classification name.

FIG. 7 It depicts a schematic diagram showing an example of candidates of classification name hierarchized into two levels.

FIG. 8 It depicts an explanatory diagram showing an example of a display showing candidates for a higher level of hierarchy.

FIG. 9 It depicts an explanatory diagram showing an example of a display showing candidates for a lower level of hierarchy.

FIG. 10 It depicts a schematic block diagram showing a configuration example of a computer for an item classification assistance system of the example embodiment of the present invention.

FIG. 11 It depicts a block diagram showing an overview of the item classification assistance system of the present invention.

FIG. 12 It depicts a schematic diagram showing an example of data that associates a commodity with a classification name.

### DESCRIPTION OF EMBODIMENTS

Hereinafter, example embodiment of the present invention will be described with reference to drawings.

In the following, the case where an item to be classified is a commodity as an example is described, but the item to be classified is not limited to a commodity; for example, the item to be classified could be an employee of a company. An item is represented by an item name. For example, when the item is a commodity, a commodity name corresponds to the item name, and when the item is an employee, an employee number corresponds to the item name.

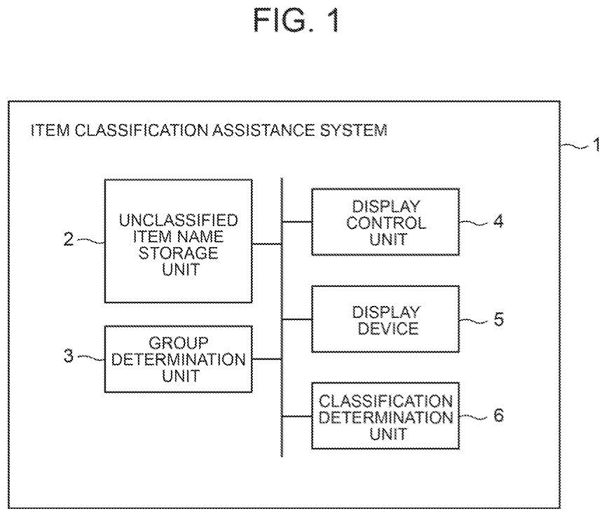

FIG. 1 is a block diagram showing a configuration example of an item classification assistance system of the example embodiment of the present invention. The item classification assistance system 1 of the example embodiment of the present invention includes an unclassified item name storage unit 2, a group determination unit 3, a display control unit 4, a display device 5, and a classification determination unit 6.

The unclassified item name storage unit 2 is a storage device that stores multiple item names of items that have not yet been classified. In this example, the unclassified item name storage unit 2 stores multiple commodity names of commodities that have not yet been classified. The administrator of the item classification assistance system 1 stores the commodity names of commodities that have not yet been classified in the unclassified item name storage unit 2 in advance.

The group determination unit 3 determines groups of commodity names from the set of commodity names (item names) of unclassified commodities (items) stored in the unclassified item name storage unit 2.

The group determination unit 3 determines groups of commodity names, for example, as follows. When determining one group, the group determination unit 3 first identifies one commodity name from the commodity names stored in the unclassified item name storage unit 2. This identified commodity name is noted as a standard commodity name. The group determination unit 3 may randomly identify one standard commodity name, or the group determination unit 3 may identify one standard commodity name using active learning.

Next, the group determination unit 3 calculates a degree of similarity with the standard commodity name for each individual commodity name other than the standard commodity name stored in the unclassified item name storage unit 2. The group determination unit 3 may, for example, calculate “a reciprocal of an edit distance between two commodity names” as the degree of similarity between the two commodity names. The more similar the commodity names are, the greater the degree of similarity, and the less similar the commodity names are, the smaller the degree of similarity.

Assume that the item name is an employee number. For example, the employee number is defined by the rule that the upper p digits represent the first of work year of employment, the next upper q digits represent the department to which the employee belongs, and so on. In such a case, a reciprocal of an edit distance between two employee numbers may be calculated as the degree of similarity between the two employee numbers.

After calculating the degree of similarity with the standard commodity name for each individual commodity name other than the standard commodity name, the group determination unit 3 may identify a predetermined number of commodity names in order of increasing degree of similarity with the standard commodity name and determine one group that includes the standard commodity name and the predetermined number of commodity names.

Alternatively, the group determination unit 3 calculates the degree of similarity with the standard commodity name for each individual commodity name other than the standard commodity name, identifies each commodity name whose degree of similarity with the standard commodity name is greater than or equal to a threshold value, and determines one group that includes the standard commodity name and each commodity name.

In the two group determination methods illustrated here, one group is determined for each standard commodity name identified.

The display device 5 is a device for displaying information and can be a common display device.

Next, the operation of the display control unit 4 is described. Here, one group determined by the group determination unit 3 is focused on. However, when the group determination unit 3 determines multiple groups, the same operation is performed for each group.

The display control unit 4 displays on the display device 5 the individual commodity names belonging to the group, and also displays on the display device 5 a plurality of candidates of classification name for each commodity represented by each commodity name belonging to the group. At this time, the display control unit 4 displays on the display device 5 the plurality of candidates of classification name in a user-specifiable manner (e.g., specifiable manner with a mouse click, etc.). The screen displayed on the display device 5 by the display control unit 4 also includes other GUI (Graphical User Interface), etc.

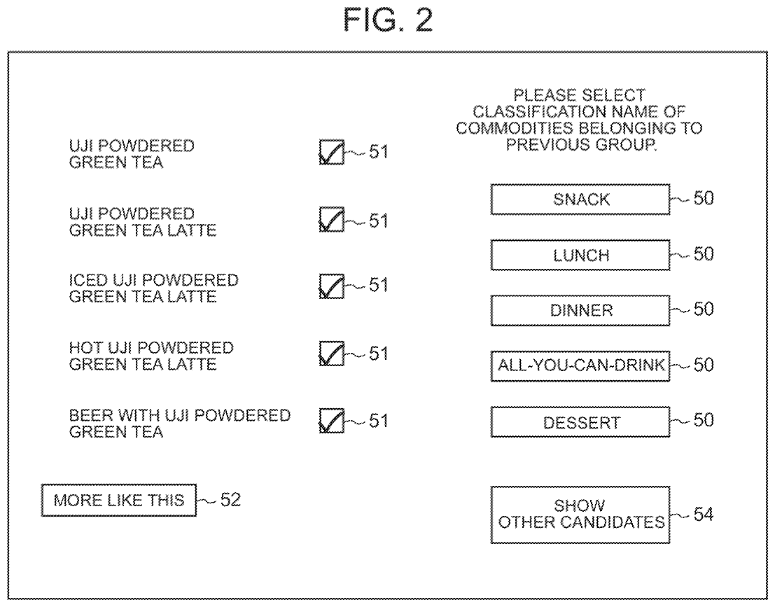

FIG. 2 is an explanatory diagram showing an example of a screen displayed on the display device 5 by the display control unit 4. The example shown in FIG. 2 shows a case in which the display control unit 4 displays five commodity names belonging to a group, such as “Uji Powdered Green Tea”, “Uji Powdered Green Tea Latte”, and so on. FIG. 2 also shows a case in which the display control unit 4 displays “snack,” “lunch,” “dinner,” “all-you-can-drink” and “dessert” as candidates 50 for classification name of each commodity represented by each commodity name. These candidates 50 can be specified by a mouse click or other operations by the user.

The plurality of candidates for classification name of commodities are predetermined. The example shown in FIG. 2 shows a case in which the display control unit 4 randomly selects and displays 5 candidates 50 from the predetermined plurality of candidates of classification name. As described below, the display control unit 4 may select a plurality of candidates to be displayed from the plurality of predetermined candidates of classification name according to each commodity name belonging to the group, and display those selected plurality of candidates on the display device 5.

The display control unit 4 also displays the button 54 illustrated in FIG. 2. The button 54 is used to switch between the multiple candidates 50 of classification name to be displayed. There may be cases in which none of the classification names displayed as the candidates 50 is appropriate as the classification name for each commodity represented by each commodity name belonging to the group. In such a case, the user instructs the switch of the candidates 50 of classification name by clicking the button 54 with the mouse or performing other operations. When the user performs an operation such as a mouse click on the button 54, the display control unit 4 switches the candidates 50 of classification name to be displayed, by selecting other plurality of candidates 50 other than the displayed candidates 50 from among a predetermined number of candidates of classification name, and displaying the plurality of candidates 50.

For example, when the button 54 is operated by the user in the state shown in FIG. 2, the display control unit 4 switches the displayed candidates 50 of classification name to several other candidates such as “alcohol”, “non-alcoholic”, etc. The “alcohol”, “non-alcoholic”, etc. listed here are examples, and the display control unit 4 may also select candidates randomly, for example, when selecting candidates after switching.

The button 54 may be operated multiple times. Each time the button 54 is operated by the user, the display control unit 4 switches the candidate 50 of classification name to be displayed.

The check box 51 shown in FIG. 2 is a GUI for the user to specify whether or not to exclude a commodity name from the group. The check box 51 is displayed for each commodity name belonging to the group. Each checkbox 51 is initially displayed with a check mark. A check in checkbox 51 indicates that the commodity name corresponding to that checkbox 51 is not excluded from the group. On the other hand, when the check box 51 is unchecked, it means that the commodity name corresponding to the check box 51 is excluded from the group.

When an operation such as a mouse click is performed on check box 51 by the user, the display control unit 4 removes the check in the check box 51 in which the operation was performed. Then, the display control unit 4 determines that the user has designated the commodity name corresponding to the check box 51 in which the operation was performed to be excluded from the group, and excludes that commodity name from the group. At this point, however, the display control unit 4 may continue to display that commodity name on the display device 5.

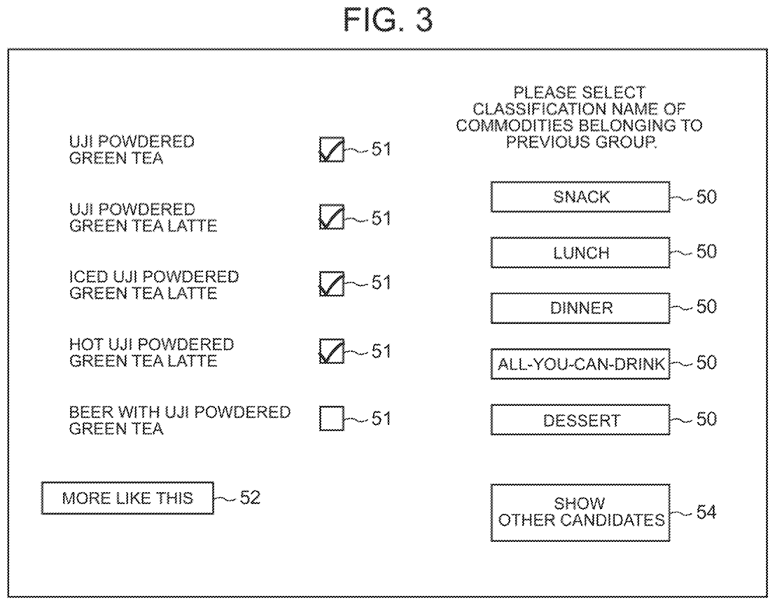

For example, in the example shown in FIG. 2, suppose that check box 51 corresponding to “Beer with Uji Powdered Green Tea” is operated by the user. In this case, the display control unit 4 removes the check from the checkbox 51 and excludes “Beer with Uji Powdered Green Tea” from the group. An example of the display at this time is shown in FIG. 3.

The display control unit 4 also displays the button 52 illustrated in FIG. 2. The button 52 is a button for the user to indicate that the number of commodity names belonging to the group should be increased. When the user indicates by the button 52 that a number of commodity names belonging to the group should be increased, the group determination unit 3 determines the commodity names to be added to the group.

For example, suppose that the group determination unit 3 had identified a predetermined number of commodity names in order of increasing degree of similarity with the standard commodity name and determine a group that includes the standard commodity name and the predetermined number of commodity names. In this case, the group determination unit 3 can further identify a certain number of commodity names from among the commodity names that were not included in the initial group in order of increasing degree of similarity with the standard commodity name, and determine those commodity names as commodity names to be added to the group.

Suppose, for example, that the group determination unit 3 had identified each commodity name whose degree of similarity with the standard commodity name is greater than or equal to a threshold value, and had determined a group that includes the standard commodity name and each commodity name. In this case, the group determination unit 3 reduces the threshold value, again identifies each commodity name whose degree of similarity with the standard commodity name is greater than or equal to is greater than the threshold value, and determines a group that includes the standard commodity name and each of those commodity names. Since the threshold value for degree of similarity is smaller, the number of commodity names belonging to this group is greater than the number of commodity names belonging to the initial group. The group determination unit 3 can determine the commodity names that do not belong to the initial group and that belong to the group determined with the smaller threshold value as the commodity names to be added to the group.

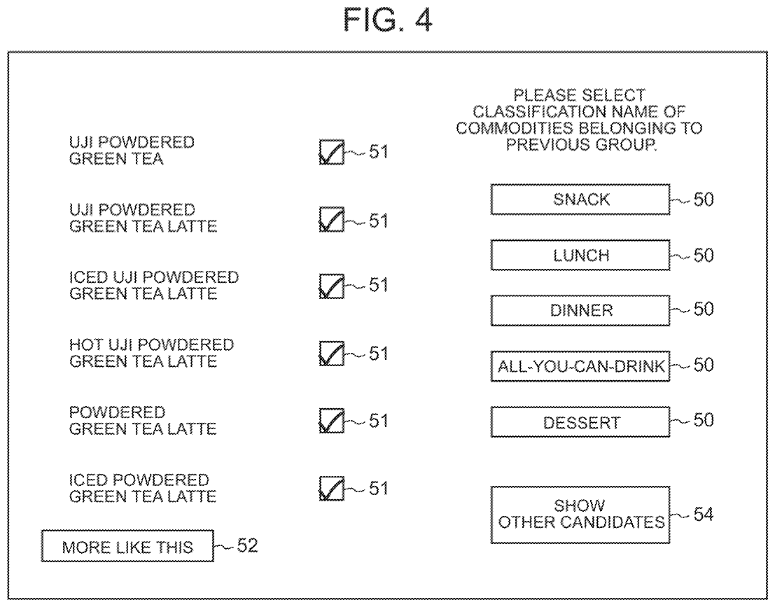

Once the group determination unit 3 has determined the commodity names to be added to the group, the display control unit 4 also displays the commodity names on the display device 5 as commodity names belonging to the group. FIG. 4 is an explanatory diagram showing an example of the display after button 52 is operated. FIG. 4 shows a case in which “Powdered Green Tea Latte” and “Iced Powdered Green Tea Latte” are additionally displayed as commodity names belonging to the group. For each of the additional commodity names, a check box 51 is also displayed. Since check box 51 has already been explained, the explanation is omitted here. At this time, the display control unit 4 does not need to display the commodity name that was excluded from the group due to the operation of check box 51 (in this example, “Beer with Uji Powdered Green Tea”). FIG. 4 illustrates the state in which “Beer with Uji Powdered Green Tea” is no longer displayed.

The button 52 may be operated multiple times. Each time the button 52 is operated by the user, the group determination unit 3 determines commodity names to be added to the group, and the display control unit 4 displays the commodity names as the commodity names that also belong to the group, on the display device 5.

When one of the plurality of the displayed candidates 50 for classification names is specified by the user by a mouse click or other operation, the classification determination unit 6 determines that each commodity represented by each commodity name belonging to the group (i.e., each displayed commodity name) is classified by the classification name specified by the user. Then, the classification determination unit 6 generates data that associates each commodity name belonging to the group with the specified classification name.

For example, suppose that the user specifies the classification name “dessert” among the candidates 50 on the screen illustrated in FIG. 3. In this case, the classification determination unit 6 determines that each commodity represented by “Uji Powdered Green Tea”, “Uji Powdered Green Tea Latte”, “Iced Uji Powdered Green Tea Latte” and “Hot Uji Powdered Green Tea Latte” shown in FIG. 3 is classified under the classification name “dessert”. The classification determination unit 6 then generates data that associates each of “Uji Powdered Green Tea”, “Uji Powdered Green Tea Latte”, “Iced Uji Powdered Green Tea Latte” and “Hot Uji Powdered Green Tea Latte” with the classification name of “dessert”. In the example shown in FIG. 3, “Beer with Uji Powdered Green Tea” is excluded from the group, so the commodity represented by “Beer with Uji Powdered Green Tea” is not included in the classification of the classification name “dessert.

For example, suppose that the user specifies the classification name “dessert” among the candidates 50 on the screen illustrated in FIG. 4. In this case, the classification determination unit 6 determines that each commodity represented by “Uji Powdered Green Tea”, “Uji Powdered Green Tea Latte”, “Iced Uji Powdered Green Tea Latte”, “Hot Uji Powdered Green Tea Latte”, “Powdered Green Tea Latte” and “Iced Powdered Green Tea Latte” shown in FIG. 4 is classified under the classification name “dessert”. The Classification determination unit 6 then generates data that associates each of “Uji Powdered Green Tea”, “Uji Powdered Green Tea Latte”, “Iced Uji Powdered Green Tea Latte”, “Hot Uji Powdered Green Tea Latte”, “Powdered Green Tea Latte” and “Iced Powdered Green Tea Latte” with the classification name of “dessert”.

For example, the group determination unit 3, the display control unit 4, and the classification determination unit 6 are realized by a central processing unit (CPU) of a computer that operates according to an item classification assistance program. For example, the CPU reads the item classification assistance program from a program storage medium such as a program storage device of the computer, and may operate as the group determination unit 3, the display control unit 4, and the classification determination unit 6 according to the item classification assistance program. The unclassified item name storage unit 2 is realized, for example, by a storage device of the computer.

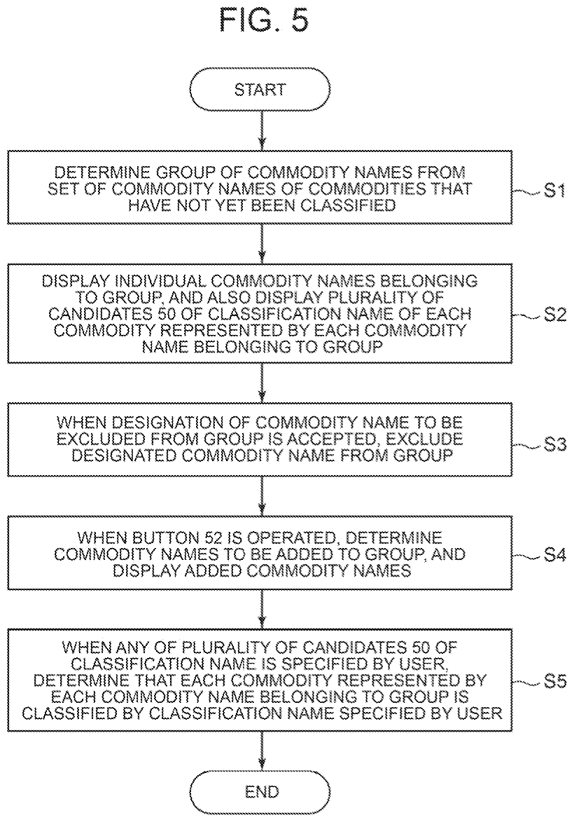

Next, the processing flow is described. FIG. 5 is a flowchart showing an example of the processing flow of the example embodiment of the present invention. Detailed explanations of matters already explained are omitted. The unclassified item name storage unit 2 stores, in advance, a plurality of commodity names of commodities that have not yet been classified.

First, the group determination unit 3 determines a group of commodity names from the set of commodity names of commodities that have not yet been classified (step S1).

Next, the display control unit 4 displays the individual commodity names belonging to the group on the display device 5, and also displays a plurality of candidates 50 (FIG. 2, etc.) of classification name of each commodity represented by each commodity name belonging to the group on the display device 5 (step S2). In step S2, the display control unit 4 displays, on display device 5, the plurality of candidates 50 of classification name in a user-specifiable manner (e.g., specifiable manner with a mouse click, etc.).

Next, when the designation of a commodity name to be excluded from the group is accepted, the display control unit 4 excludes the designated commodity name from the group (step S3). In the present example embodiment, the operation to designate a commodity name to be excluded from the group is to click the mouse on the check box 51 (see FIG. 2, etc.) corresponding to the commodity name to be excluded from the group, and to remove the check in the check box. The display control unit 4 excludes the commodity name corresponding to the check box 51 in which the operation is performed from the group.

When the button 52 (see FIG. 2, etc.) is operated, the group determination unit 3 determines the commodity names to be added to the group, and display control unit 4 displays, on the display device, the commodity names as the commodity names belonging to the group (step S4).

Steps S3 and S4 may be executed multiple times in response to user operations on the GUI (the check boxes 51 and the buttons 52) until the user determines that the group of commodity names displayed is appropriate. When no operation to designate the commodity names to be excluded (no operation on the check boxes 51) is performed, step S3 may not be performed. When no operation is performed on the button 52, step S4 may not be performed.

When any of the plurality of candidates 50 (see FIG. 2, etc.) of classification name is specified by the user, the classification determination unit 6 determines that each commodity represented by each commodity name belonging to the group is classified by the classification name specified by the user (step S5). At this time, the classification determination unit 6 generates data that associates each commodity name belonging to the group with the specified classification name.

When a mouse click or other operation on the button 54 (see FIG. 2, etc.) is performed by the user before moving to step S5, the display control unit 4 switches the candidate 50 of classification names to be displayed.

According to the present example embodiment, the group determination unit 3 determines groups of commodity names. Then, the display control unit 4 displays the individual commodity names belonging to the group on the display device 5, as well as the plurality of candidates 50 (see FIG. 2, etc.) for the classification name of each commodity represented by each commodity name belonging to the group on the display device 5. When any of the plurality of candidates 50 of the classification name is specified by the user, the classification determination unit 6 determines that each commodity represented by each commodity name belonging to the group is classified by the classification name specified by the user. Therefore, once the user specifies one of the plurality of candidates 50 for the classification name, the user can combine each commodity represented by each commodity name belonging to the group into one classification and also determine the classification name for that classification. In other words, the user can determine the classification name of classification of multiple commodities with a simple operation. Therefore, the load on the user can be significantly reduced compared to the general method of manually defining the classification name for each commodity.

In the present example embodiment, when the operation to uncheck the check box 51 is performed by the user, the display control unit 4 excludes the commodity name corresponding to the check box 51 from the group. Thus, the user can exclude commodity names that fall outside of the group from the commodity names belonging to the group, etc., and can adjust the commodity names belonging to the group so that they become an appropriate group.

In the present example embodiment, the number of commodity names belonging to a group is increased when the operation to the button 52 is performed by the user. Thus, the number of commodity names belonging to the group can be increased. As a result, an effect of combining each commodity represented by each commodity name belonging to the group into one classification and determining the classification name of the classification can be further improved.

In the above example embodiment, the explanation focuses on the case where the item to be classified is a commodity and the item name is a commodity name. However, the item to be classified is not limited to a commodity, and therefore the item name is not limited to a commodity name.

Next, a variation of the above example embodiment is described.

In the above example embodiment, the display control unit 4 randomly selects and displays a plurality of candidates 50 (five candidates in the example shown in FIG. 2, etc.) from a plurality of predetermined classification name candidates. The display control unit 4 may select a plurality of candidates to be displayed from the plurality of predetermined classification name candidates according to each commodity name belonging to the group, and display the selected plurality of candidates on the display device 5.

An example of the operation of selecting the plurality of candidates to be displayed according to each commodity name belonging to a group is shown below. For example, the display control unit 4 may select a candidate for a classification name that includes a character string commonly included in all or part of each commodity name belonging to the group, and display the candidate for the classification name on the display device 5. For example, suppose that the group includes the commodity names “Japanese spirits with orange”, “Japanese spirits with lemon”, and “Japanese spirits with oolong tea”. Also, suppose that “Japanese spirits” and “spirits” exist as predefined candidates for a classification name. In this case, the display control unit 4 may select “Japanese spirits” and “spirits” from among the predefined candidates of classification name according the commodity names “Japanese spirits with orange”, “Japanese spirits with lemon”, and “Japanese spirits with oolong tea”, and display “Japanese spirits” and “spirits” as candidates 50 of classification name.

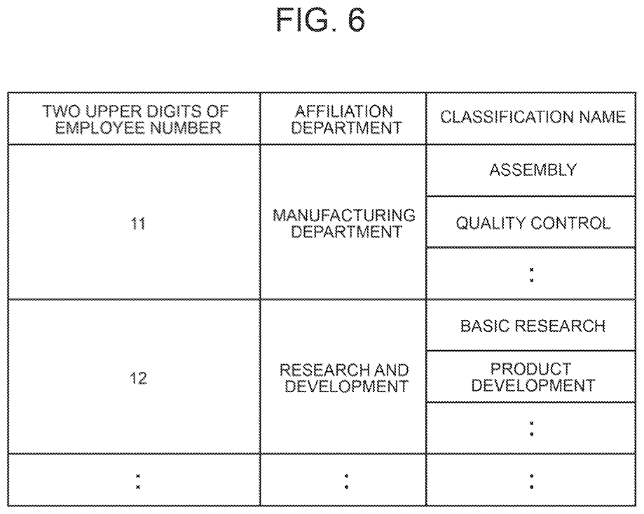

Also suppose that the item is an employee of a company and the item name is an employee number. In the example below, it is assumed that the employee number is defined by a rule such that the two upper digits represent the department to which the employee belongs, and so on. Then, it is assumed that each employee number belonging to a group is a number starting with “11”, such as “1120159999”, “1120160784”, “1120110634”, and so on. Furthermore, assume that the relationship shown in FIG. 6 is defined as the relationship between the two upper digits of the employee number, an affiliation department, and the predefined candidates of classification name. In this example, since each employee number belonging to the group is a number starting from “11”, the display control unit 4 selects classification names such as “Assembly” or “Quality Control” from the predefined candidates of classification names based on the predefined relationship shown in FIG. 6, and displays the classification names as candidates 50 of classification name.

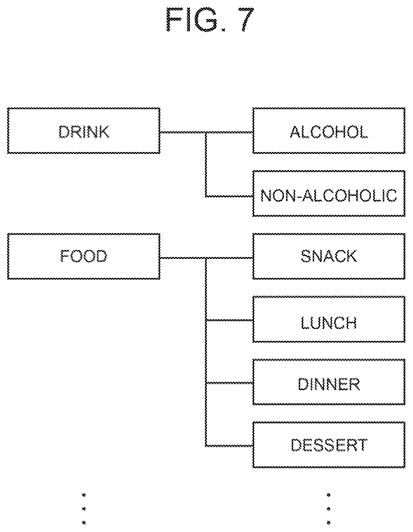

When the candidates of classification name are hierarchical and the higher level classification name is selected, the display control unit 4 may display the candidates of classification name of the lower level of the selected classification name so that the user can also select the lower level classification name. For simplicity of explanation, the case where the candidates of classification name are hierarchized into two levels is described, but the candidates of classification name may be hierarchized into three or more levels. FIG. 7 is a schematic diagram showing an example of candidates of classification name hierarchized into two levels.

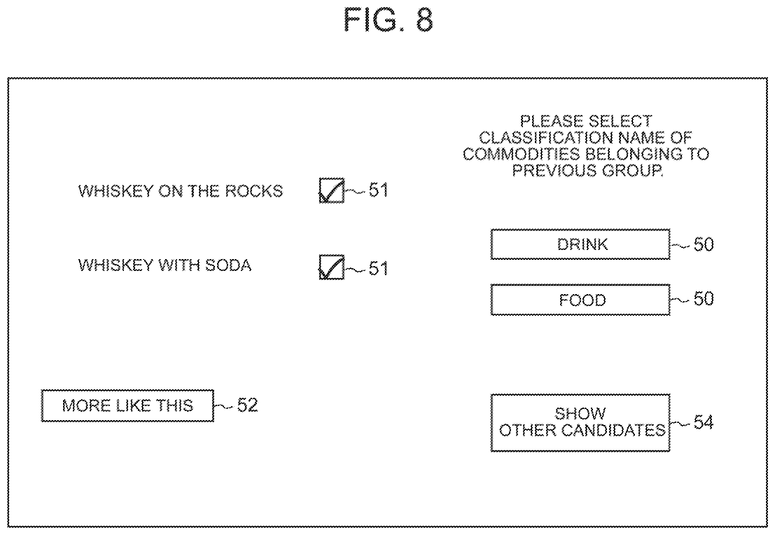

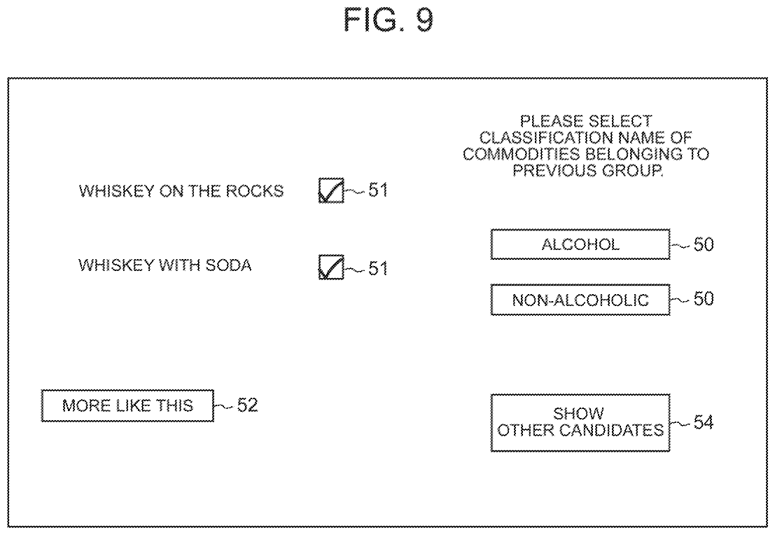

In this example, it is assumed that the display control unit 4 displays the screen illustrated in FIG. 8 on the display device 5. The candidates 50 of classification name shown in FIG. 8 are all candidates for higher levels of hierarchy (see FIG. 8 and FIG. 7). It is assumed that “drink” shown in FIG. 8 is specified by the user. In this case, the candidates for the classification name of the lower level of the hierarchy of “drink” are displayed. In this example, the screen shown in FIG. 9 is displayed. It is assumed that “alcohol” shown in FIG. 9 is specified by the user. Then, the classification determination unit 6 classifies the commodity names “whiskey on the rocks” and “whiskey with soda” shown in the groups shown in FIGS. 8 and 9 under the classification name “drink,” and also classifies the commodity names under the classification name “alcohol”. The classification determination unit 6 then generates data that associates each commodity name belonging to the group with the specified classification names “drink” and “alcohol.

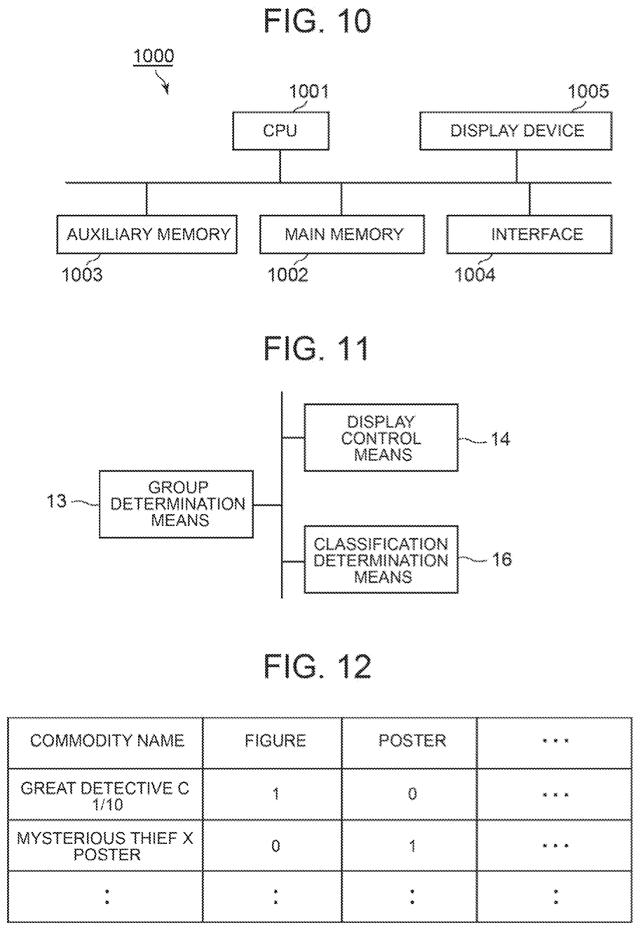

FIG. 10 is a schematic block diagram showing a configuration example of a computer for the item classification assistance system 1 of the example embodiment of the present invention. For example, a computer 1000 includes a CPU 1001, a main memory 1002, an auxiliary memory 1003, an interface 1004, a display device 10 05.

The item classification assistance system 1 of the example embodiment of the present invention is realized by the computer 1000. The operation of the item classification assistance system 1 is stored in the form of a program (an item classification assistance program) in the auxiliary memory 1003. The CPU 1001 reads the program from the auxiliary memory 1003, deploys the program to the main memory 1002, and executes the processing described in above example embodiment according to the program. In this case, the group determination unit 3, the display control unit 4, and the classification determination unit 6 are realized by the CPU1001. The display device 5 is realized by the display device 1005.

The auxiliary memory 1003 is an example of a non-transitory tangible medium. Other examples of non-transitory tangible media are a magnetic disk, an optical magnetic disk, a CD-ROM (Compact Disk Read Only Memory), a DVD-ROM (Digital Versatile Disk Read Only Memory), a semiconductor memory, and the like, which are connected through the interface 1004. When the program is delivered to the computer 1000 through a communication line, the computer 1000 that receives the delivery may deploy the program into the main memory 1002 and execute the processing described in the above example embodiment according to the program.

Some or all of the components may be realized by general-purpose or dedicated circuitry, processors, or a combination of these. They may be configured by a single chip or by multiple chips connected via a bus. Some or all of the components may be realized by a combination of the above-mentioned circuitry, etc. and a program.

When some or all of each component is realized by multiple information processing devices, circuits, etc., the multiple information processing devices, circuits, etc. may be centrally located or distributed. For example, the information processing devices, circuits, etc. may be implemented as a client-and-server system, a cloud computing system, etc., each of which is connected via a communication network.

The following is an overview of the invention. FIG. 11 is a block diagram showing an overview of the item classification assistance system of the present invention. The item classification assistance system of the present invention includes a group determination means 13, a display control means 14, and a classification determination means 16.

The group determination means 13 (e.g., the group determination unit 3) determines a group of item names from a set of item names of unclassified items.

The display control means 14 (e.g., the display control unit 4) displays individual item names belonging to the group, and displays a plurality of candidates of a classification name for each item represented by each item name belonging to the group in a user-specifiable manner.

When one of the plurality of candidates of the classification name is specified by a user, the classification determination means 16 (e.g., the classification determination unit 6) determines that each item represented by each item name belonging to the group is classified by the classification name specified by the user.

According to such a configuration, it is possible to assist users to easily define a classification name of items to be classified.

The display control means 14 may display a GUI (e.g., check box 51) to specify whether or not to exclude an item name from the group for each item name belonging to the group, and exclude the item name specified to exclude from the group by the user from the group.

The display control means 14 may display a button (e.g., the button 52) to indicate that a number of item names belonging to the group should be increased, the classification determination means 16 may determine item names to be added to the group when indicated that the number of item names belonging to the group should be increased by the button, and the display control means 14 may display the item names that have been added to the group.

The display control means 14 may select the plurality of candidates to be displayed from a plurality of predetermined candidates of the classification name, according to each item name belonging to the group, and display the selected plurality of candidates.

The display control means 14 may switch the candidates of the classification name to be displayed according to the user's operation.

Although the invention of the present application has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The invention is suitably applicable to an item classification assistance system that assists in the classification of items.

### REFERENCE SIGNS LIST

1 Item classification assistance system
2 Unclassified item name storage unit
3 Group determination unit
4 Display control unit
5 Display device
6 Classification determination unit

What is claimed is:

1. An item classification assistance system comprising:
a group determination unit, implemented by a processor, and that determines a group of item names from a set of item names of unclassified items;
a display control unit, implemented by the processor, and that displays individual item names belonging to the group, and displays a plurality of candidates of a classification name for each item represented by each item name belonging to the group in a user-specifiable manner; and
a classification determination unit, implemented by the processor, and that, when one of the plurality of candidates of the classification name is specified by a user, determines that each item represented by each item name belonging to the group is classified by the classification name specified by the user.

2. The item classification assistance system according to claim 1, wherein
the display control unit displays a GUI (Graphical User Interface) to specify whether or not to exclude an item name from the group for each item name belonging to the group, and excludes the item name specified to exclude from the group by the user from the group.

3. The item classification assistance system according to claim 1, wherein
the display control unit displays a button to indicate that a number of item names belonging to the group should be increased,
the classification determination unit determines item names to be added to the group when indicated that the number of item names belonging to the group should be increased by the button, and
the display control unit displays the item names that have been added to the group.

4. The item classification assistance system according to claim 1, wherein
the display control unit selects the plurality of candidates to be displayed from a plurality of predetermined candidates of the classification name, according to each item name belonging to the group, and displays the selected plurality of candidates.

5. The item classification assistance system according to claim 1, wherein
the display control unit switches the candidates of the classification name to be displayed according to the user's operation.

6. An item classification assistance method, wherein one or more computers
determine a group of item names from a set of item names of unclassified items;
display individual item names belonging to the group, and display a plurality of candidates of a classification name for each item represented by each item name belonging to the group in a user-specifiable manner; and
when one of the plurality of candidates of the classification name is specified by a user, determine that each item represented by each item name belonging to the group is classified by the classification name specified by the user.

7. A non-transitory computer-readable recording medium in which an item classification assistance program is recorded, wherein the item classification assistance program causes a computer to execute:
a group determination process of determining a group of item names from a set of item names of unclassified items;
a display control process of displaying individual item names belonging to the group, and displaying a plurality of candidates of a classification name for each item represented by each item name belonging to the group in a user-specifiable manner; and
a classification determination process of, when one of the plurality of candidates of the classification name is specified by a user, determining that each item represented by each item name belonging to the group is classified by the classification name specified by the user.
